(19) United States
(12) Patent Application Publication
(10) Pub. No.: US 2014/0270783 A1
(43) Pub. Date: Sep. 18, 2014

(54) RADIO-FREQUENCY SIGNAL REPETITION AND AMPLIFICATION USING PHASE-MODULATION INJECTION-LOCKED LASERS

(71) Applicant: PHASE SENSITIVE INNOVATIONS, INC, Newark, DE (US)

(72) Inventors: Dennis W. Prather, Newark, DE (US); Garrett Schneider, New Castle, DE (US); Janusz Murakowski, Newark, DE (US)

(73) Assignee: PHASE SENSITIVE INNOVATIONS, INC, Newark, DE (US)

(21) Appl. No.: 13/804,483

(22) Filed: Mar. 14, 2013

(51) Int. Cl. H04B 10/2575

(52) U.S. Cl. CPC H04B 10/25752
USPC 398/115

(57) ABSTRACT

A method and apparatus for regenerating a received radio frequency (RF) signal may mix the received RF signal with a first laser signal, and the result, or a filtered version thereof, may be used to injection-seed a second laser. The result may be mixed with the first laser signal, and the result may be detected to provide a regenerated version of the received RF signal.

### FIELD OF THE INVENTION

Embodiments of the invention may relate to methods and/or apparatus for signal repetition using laser-based techniques.

### BACKGROUND

Conventional signal repeaters used in wireless radio-frequency (RF) communication networks generally suffer from significant bandwidth and latency limitations. Such conventional repeaters may typically down-convert the signal (by RF mixing and extracting the information content from the RF carrier) and then digitize it, before reapplying it to a newly-generated RF carrier and retransmitting it. This process may compromise both bandwidth and latency, and it may also compromise fidelity, especially for analog signals and/or signals borne on high-frequency RF carriers. Furthermore, this process requires complicated, cumbersome systems.

### BRIEF SUMMARY OF EMBODIMENTS OF THE INVENTION

Various embodiments of the present invention may provide apparatus and/or methods for signal regeneration based on injection-locked laser-based techniques.

### BRIEF DESCRIPTION OF THE DRAWINGS

Various embodiments of the invention will now be described in conjunction with the accompanying drawings, in which:

FIG. 1 shows a conceptual block diagram of an apparatus according to an embodiment of the invention; and

FIG. 2 shows a flowchart of a method according to an embodiment of the invention.

### DETAILED DESCRIPTION OF EMBODIMENTS OF THE INVENTION

Embodiments of the invention may include a device for regenerating radio-frequency (RF) signals, for example, as in a wireless microwave communications system, such as a cell phone network, but not limited thereto. The process may be an analog process, in which the RF signals are received and regenerated without demodulation and reconditioning. A mechanism according to embodiments of the invention may exploit the process of injection seeding, in which a small amount of optical energy is extracted from a laser's output signal and injected into the cavity of a second laser, which may thus render the second laser coherent (i.e., phase-locked) with the first laser. The injected signal (seed), if sufficiently powerful, may cause the injected laser to oscillate synchronously with the source of the seed.

FIG. 1 may be used to further explain this concept. FIG. 1 shows a first laser 101 and a second laser 103. An input RF signal to be regenerated may be received, e.g., via an antenna 102 and may optionally be amplified. The first laser 101 may be used to generate a seed laser signal (“seed”), which may be obtained from an output of splitter 104. Before injecting the seed into the second laser 103, it may be modulated with the input RF signal to be regenerated, which may be done using modulator 105. One implementation of modulator 105 may be as an electro-optic phase modulator, which may be used to encode the amplitude of the input RF signal onto the phase of the seed. The seed, at the output of modulator 105, may thereby contain a total phase comprised of its own intrinsic phase noise, superimposed with the input RF signal. As a result, in effect, the input RF signal may be upconverted from the RF domain into the optical domain, i.e. it may appear as sidebands on the output spectrum of the seed laser signal, offset from the seed laser's intrinsic oscillation frequency (the optical carrier) by the frequency of the input RF signal's carrier wave. It is noted that this upconversion process may serve to preserve the phases of the contributing signals, both RF and optical.

Next, the seed signal may pass through an optical bandpass filter 106, which may be used to pass one of the generated sidebands, but which may block the optical carrier frequency. The remaining seed signal may thus have the combined phase of the first laser 101 and the input RF signal and may be offset from the frequency of the first laser 101 by the RF carrier frequency. The resulting filtered seed may then be injected into the second laser 103, using an injection arrangement, such as, but not limited to using optical circulator 107. This may be followed by combining (mixing) the two lasers' 101, 103 outputs, e.g., using a combiner 108. The result may then be forwarded to a detector, such as photodiode detector 109. The photocurrent produced by detector 109 may, when applied to an appropriate electrical load (e.g., a matched transmission line), faithfully regenerate the input RF signal. This is because the intrinsic noise components of the lasers' 101, 103 phases may be identical, and hence may not contribute to the time-varying component of the photocurrent, but may rather cancel out, yielding only a direct current (DC) contribution to the output of detector 109. The output of detector 109 may then optionally be amplified and retransmitted by transmit antenna 110. Owing to the superposition principle obeyed by the total electric field incident on the detector 109, the amplitude of the time-varying photocurrent (and hence of the output RF signal) may be proportional to the sine of the lasers' mutual phase difference. For small input signal amplitudes, this may be approximately equal to the phase difference, and hence proportional to the input RF signal.

FIG. 2 shows a method according to an embodiment of the invention. A received RF signal may be modulated 201 onto a first laser signal (i.e., to create the seed signal). The resulting modulated optical signal may then be filtered 202 to obtain an optical signal having one sideband and with the optical carrier blocked. The resulting filtered signal may then be injected 203 into a second laser. The injection-seeded laser signal may then be mixed/combined 204 with the first laser signal (i.e., the laser signal that was used to create the seed signal). The resulting signal may undergo detection 205. The detection output may then be applied to a load/retransmitted 206. The method may further comprise other operations corresponding to the description of the embodiments of FIG. 1, as well as those discussed below.

The various embodiments of the present invention may enable signal regeneration nearly instantaneously, with latency limited only by the speed-of-light signal propagation time and by the injected laser's quality factor (Q), which determines how quickly it can lock to the injected seed signal. Rough calculations indicate system latency can be of sub-nanosecond-order. Owing to the extremely wide operating bandwidth of optical phase modulators (up to 300 GHz demonstrated in the inventors' laboratories, with commercial products available at >40 GHz), embodiments of the invention may be capable of faithfully capturing RF signals with very high carrier frequencies (e.g., but not limited to, 94 GHz, a promising frequency for wireless line-of-sight links due to atmospheric transparency), and instantaneous bandwidths limited by the injection locking range. Further, the amplitude of the locked laser output may, in view of the above-described processes, be independent of the amplitude of the seed signal, and only its phase may be governed by the injection. Therefore, the regenerated signals may thus be automatically gain-corrected to the same output strength, regardless of the strength of the input signal, provided that the input signal is sufficiently strong to generate a modulation sideband with enough optical power to injection seed, or that it can be made so by amplification (input to the optical modulator or the injection-seeded laser, or both, can be amplified to boost the seed if needed).

It is noted that typical semiconductor distributed feedback (DFB) lasers may have a locking range that can be several hundred MHz, perhaps up to 1 GHz, depending on the injected power level. If the incident carrier frequency is not within this range of the injected laser's free-running oscillation frequency, locking may not occur. Hence, in embodiments of the invention, the lasers may be pre-tuned to be offset in frequency by the input RF signal's carrier frequency, plus or minus half of the injected laser's locking range, less an additional margin to allow for the bandwidth of the information-bearing signal borne by the input RF signal.

The finite locking range may constitute another limitation as well, in that even if the input RF signal's carrier is well centered on the locked laser's free-running frequency, the instantaneous bandwidth (IBW) of the input RF signal may need to be less than or equal to the locking range for a signal to be faithfully regenerated. As an example, if the input RF signal's IBW is 500 MHz, but the locking range is 300 MHz, then high frequency components of the signal may be attenuated by the locking range (i.e., conceptually, the locking range may act as a low-pass filter on the information content borne by the input RF signal). This may be addressed, in various embodiments of the invention, by judicious choice of the laser cavity design. Rough calculations estimate that lasers may be engineered with relatively low cavity Q factors, such that a locking range on an injection level of −20 dB (with respect to the output amplitude) could be as large as 20 GHz, which may be sufficiently large to accommodate typical RF signals.

A secondary issue is that it may be necessary to amplify the input RF signal before it can efficiently modulate the optical seed. An amplifier used in this role may need to provide sufficiently high gain and may need to provide a bandwidth covering the input RF signal carrier frequencies in use. Alternatively, optical amplification may be used to boost the optical seed (i.e., following modulation of the input RF signal onto the seed laser signal), which would typically not suffer from any practical bandwidth limitation. However, either type of amplification may add noise.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

What is claimed is:

1. A radio frequency (RF) signal regenerator comprising:
first and second lasers;
a modulator configured to modulate a received RF signal onto an output signal of the first laser to obtain a seed signal;
an injection arrangement configured to inject the seed signal into the second laser to obtain an injection-seeded signal as an output of the second laser;
a combiner configured to combine an output of the first laser with the injection-seeded signal to obtain a combined signal; and
a detector configured to detect an output RF signal from the combined signal.

2. The regenerator of claim 1, further comprising a beam splitter coupled to the output signal of the first laser and configured to provide output signals to the modulator and the combiner.

3. The regenerator of claim 1, further comprising a receive antenna configured to receive the received RF signal.

4. The regenerator of claim 1, further comprising a transmit antenna coupled to the detector and configured to transmit the output RF signal.

5. The regenerator of claim 1, wherein the detector comprises a photodiode.

6. The regenerator of claim 1, further comprising one or more of the following:
at least one amplifier configured to amplify the received RF signal prior to the modulator, or
at least one amplifier configured to amplify the output signal of the first laser prior to the modulator.

7. The regenerator of claim 1, further comprising an optical bandpass filter disposed between the modulator and the optical circulator.

8. The regenerator of claim 7, wherein the optical bandpass filter is configured to pass one sideband of the seed signal and to filter out an optical carrier frequency of the seed signal.

9. The regenerator of claim 1, further comprising an amplifier configured to amplify an output of the detector.

10. The regenerator of claim 1, wherein the injection arrangement comprises an optical circulator.

11. A method of regenerating a received radio frequency (RF) signal, the method comprising:
modulating the received RF signal onto an output signal of a first laser to obtain a seed signal;
injecting the seed signal into a second laser to obtain an injection-seeded signal;
mixing the first laser signal with the injection-seeded signal; and
detecting a result of the mixing.

12. The method of claim 11, further comprising bandpass filtering the seed signal prior to the injecting.

13. The method of claim 11, further comprising retransmitting an output of the detecting.

14. The method of claim 13, further comprising amplifying the output of the detecting prior to the retransmitting.

15. The method of claim 11, further comprising amplifying the received RF signal prior to the modulating.

16. The method of claim 11, further comprising amplifying the output signal of the first laser prior to the modulating.

17. The method of claim 11, further comprising the pre-tuning frequencies of the first laser and the second laser to be offset from each other by an amount approximately equal to the received RF signal's carrier frequency, within plus or minus half of a locking range of the second laser.

18. The method of claim 17, wherein the amount approximately equal to the received RF signal's carrier frequency accounts for a margin to allow for a bandwidth of an information-bearing signal borne by the received RF signal.
